(19) United States
(12) Patent Application Publication
(10) Pub. No.: US 2005/0216941 A1
(43) Pub. Date: Sep. 29, 2005

(54) System and method for controlling video-on-demand content

(75) Inventors: Mark Flanagan, Flower Mound, TX (US); Mark Vevera, Dallas, TX (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Primedia Workplace Learning, LP, Carrollton, TX (US)

(21) Appl. No.: 10/809,801

(22) Filed: Mar. 26, 2004

(51) Int. Cl. H04N 7/173

(52) U.S. Cl. 725/88; 725/102; 725/112

(57) ABSTRACT

A system for remotely controlling playback of VOD content is provided. The system comprises at least one receiving station for receiving and playing VOD content; and a control station for remotely controlling the VOD content over a communication network, the control station selectively transmitting a control signal to the at least one receiving station for controlling initiation of the VOD content. A method for remotely controlling content is also provided. The method comprises identifying at least one receiving station to control; transmitting a control signal over a communications network to the at least one receiving station; and controlling the content at the at least one receiving station.

### FIELD OF THE INVENTION

The invention relates generally to a system and method for providing video-on-demand content, and more particularly to a system and method for delivering, controlling and administering video-on-demand content in a secure and real-time manner.

### BACKGROUND OF THE INVENTION

Video-on-demand (“VOD”) is a revolutionary technology. Developments over the past few years have enabled television viewers to schedule and watch programming at their convenience. No longer do people have to get home from work at a certain time in order to watch their favorite show. Nor do people have to master the daunting task of programming their video cassette recorder (VCR) to record a show or movie at a particular date and time. Almost literally, a viewer is now only a few clicks or button depressions away from his or her favorite movie.

Typical video-on-demand systems operate as follows. A viewer—usually a cable or satellite subscriber—tunes-in to a channel dedicated to receive VOD content or programming, which is usually stored and maintained at a remote location by the cable or satellite provider. Once tuned-in, the viewer may interact with a graphical program guide, for example, to access and scan a catalog of available VOD programming. The program guide may display relevant programming information such as title, description, rating, running time, and cast, for example. Once the viewer decides what he or she wants to watch, the selected programming may be “downloaded” to the user's set-top box, for example, over a communications network, such as a satellite or cable network, the Internet, or the public-switched telephone network (or PSTN). When transfer is complete, on-demand functions (e.g., play, fast-forward, pause, rewind, etc.) may be initiated by the viewer at his or her convenience.

Although VOD has been a success in the home front, it suffers from several drawbacks that limit its range or scope of application. One notable drawback is the inability of the provider (e.g., cable or satellite provider) to remotely control or administer on-demand functionality at the receiver end. Normally, once VOD content is transferred to a viewer's set-top box, for example, it is outside the reach and control of the cable or satellite provider.

Another drawback is the inability of the provider to track, assess, and/or gauge performance and behavior at the receiving end or station. That is, once VOD content or programming is delivered, the cable or satellite provider is unable to monitor the recipient's interaction with the VOD content or programming, and is thus unable to assess such behavior in a real-time manner, such as through online testing measures, or basic survey functions, for example.

These and other problems exist.

### SUMMARY OF THE INVENTION

An object of the present invention is to overcome the aforementioned and other drawbacks existing in prior art systems and methods.

According to one embodiment of the invention, a system for remotely controlling playback of VOD content is provided. The system comprises at least one receiving station for receiving and playing VOD content; and a control station for remotely controlling the VOD content over a communication network, the control station selectively transmitting a control signal to the at least one receiving station for controlling initiation of the VOD content.

In another embodiment of the invention, a system for transmitting and controlling VOD content is provided. The system comprises: at least one receiving station for playing VOD content, the at least one receiving station comprising a downloading module for downloading the VOD content, and at least one storage means for storing the VOD content; and a control station for transmitting the VOD content, the control station comprising a transmission module for transmitting the VOD content over a communications network, and a controlling module for selectively controlling the transmitted VOD content once it is received at the at least one receiving station.

In yet another embodiment, a system for initiating on-demand administration of video content is provided. The system comprises: a receiving station having control means for controlling video content; and a control station for interacting with the control means to remotely administer the video content.

In another embodiment, a method for remotely controlling content is provided. The method comprises: identifying at least one receiving station to control; transmitting a control signal over a communications network to the at least one receiving station; and controlling the content at the at least one receiving station.

In another embodiment, a method for controlling VOD content stored at a receiving station is provided. The method comprises: receiving a control signal over a communications network from a control station; and allowing the control signal to control stored VOD content.

In yet another embodiment, a system for remotely controlling VOD is provided. The system comprises: means for transmitting VOD content to at least one receiving station; and means for remotely controlling the VOD content once it is received by the receiving station.

In another embodiment, a method for controlling VOD content stored at a receiving station is provided. The method comprises: sending a control signal over a communications network to a receiving station; and controlling stored VOD content via the control signal.

In still another embodiment, a system for controlling VOD content stored at a receiving station is provided. The system comprises: means for sending a control signal over a communications network to a receiving station; and means for controlling stored VOD content via the control signal.

In another embodiment, a system for controlling VOD content stored at a receiving station is provided, comprising: means for receiving a control signal over a communications network from a control station; and means for allowing the control signal to control stored VOD content.

According to various embodiments, the systems and methods described herein may be used to update or message an audience with new information, such as audiences running or using an organization-wide content network, for example. One example of content used to update or message an audience may comprise a special report or broadcast interruption on commercial television, for example, which prevents the audience from changing the channel or otherwise opting-out of the content.

In still other various embodiments, the systems and methods disclosed herein may be used to transmit encrypted VOD content, such as where content transmitted to one or more recipients may be encrypted and decrypted for playback (or any other remote or local control function). In some embodiments, content initiation may be limited to those recipients having a valid decryption key(s).

In various other embodiments, the systems and methods discussed herein may be used to permit remote uploading. That is, users with proper authority, for example, may be able to remotely contribute and upload VOD content. For example, VOD content may be contributed over a network system, such as the Internet, or through any other communications network. The contributed content may then be transmitted and controlled as described herein.

In still other various embodiments, the systems and methods disclosed herein may be used to permit users to request additional VOD content to be received, uploaded, and/or transmitted, for example. For example, a user at a receiving or control station may request particular programming by initiating a request through a graphical user interface. Other methods for requesting programming are possible. The requested content may then be transmitted and controlled as described herein.

In still other embodiments, the systems and methods discussed herein may be used to permit messaging between various users, such as between users at various control and/or receiving stations, for example. For instance, a network operator stationed at a control or receiving stations may notify or inform other users of system status, for example, or the availability of system features, techniques, content and/or programming, for example.

The accompanying drawings, which are incorporated in and constitute a part of this specification, illustrate various embodiments of the invention and, together with the description, serve to explain the principles of the invention.

### BRIEF DESCRIPTION OF THE DRAWINGS

FIG. 1 is a block diagram illustrating a system for providing, controlling, and administering VOD content or programming, according to one embodiment of the invention.

FIG. 2 is a block diagram illustrating a control center, according to one embodiment of the invention.

FIG. 2a is a block diagram illustrating exemplary modules associated with the control center of FIG. 2, according to one embodiment of the invention.

FIG. 3 is a block diagram illustrating a receiving station, according to one embodiment of the invention.

FIG. 3a is a block diagram illustrating exemplary modules associated with the receiving stations of FIG. 1b, according to one embodiment of the invention.

FIG. 4 is a block diagram illustrating a system for providing, controlling, and administering VOD content, according to one embodiment of the invention.

FIG. 5 illustrates a method for remotely controlling content, according to one embodiment of the invention.

FIG. 6 illustrates a method for controlling VOD content stored at a receiving station, according to one embodiment of the invention.

FIG. 7 illustrates one embodiment of an illustrative home interface associated with receiving stations, according to one embodiment of the invention.

FIG. 8 illustrates one embodiment of an illustrative interface page illustrating a select list of VOD content or programming, according to one embodiment of the invention.

FIG. 9 illustrates an initiated alert being presently displayed on a screen area, according to one embodiment of the invention.

FIG. 10 illustrates an illustrative interface associated with a channel, according to one embodiment of the invention.

FIG. 11 illustrates an illustrative interface displaying the daily play list associated with a channel, according to one embodiment of the invention.

FIG. 12 illustrates one embodiment of an illustrative interface displaying the catalog of stored VOD content or programming, according to one embodiment of the invention.

FIG. 13 illustrates one embodiment of an illustrative interface displaying a user's completion of VOD content or programming, according to one embodiment of the invention.

FIG. 14 illustrates an illustrative interface displaying an incoming emergency alert or notification, according to one embodiment of the invention.

### DETAILED DESCRIPTION OF THE INVENTION

Reference will now be made to illustrative embodiments of the invention(s) described herein, examples of which are illustrated in the accompanying drawings in which like reference characters refer to corresponding elements.

The present invention(s) are described in relation to various systems and methods for transmitting and controlling VOD content or programming. Nonetheless, the characteristics and parameters pertaining to the various embodiments of the systems and methods described herein may be applicable to transmission and administration of other types of content.

While the exemplary embodiments illustrated herein may show various embodiments of the invention (or portions thereof) collocated, it is to be appreciated that the various components of the various embodiments may be located at distant portions of a distributed network, such as a local area network, a wide area network, a telecommunications network, an intranet and/or the Internet, or within a dedicated object handling system, for example. Thus, it should be appreciated that the components of the various embodiments may be combined into one or more devices (or modules) or collocated on a particular node of a distributed network, such as a telecommunications network, for example. As will be appreciated from the following description, and for reasons of computational efficiency, the components of the various embodiments may be arranged at any location within a distributed network without affecting the operation of the respective system(s).

Various embodiments of the systems and methods described herein may comprise or include a system and method for transmitting VOD content or programming to one or any number of receiving stations where such VOD content or programming may be selectively played back, for example. According to various embodiments, the methods and systems may remotely control or administer (e.g., from the control or originating station) various aspects of the VOD content or programming following transmission to the receiving station(s). For example, the control station may selectively control the playback of the VOD content, or may control the maintenance of such content or programming (e.g., catalog) at the receiving station, for example. Such remote control may be effected by transmitting control signals over any number of communication networks—e.g., satellite or cable network, the Internet, any telecommunication network, or any other type or form of communication network—connecting a control center and various receiving stations.

In various other embodiments, such remote control may enable government agencies, for example, to issue real-time alerts and notifications to various first-responders and thus reduce their ever-critical response time. For instance, embodiments of methods and systems described may be used to interrupt programming currently playing at one or any number of receiving stations to make way for urgent alerts and notifications, such as mandatory governmental warnings or instructions to first responders, for example. The interrupted programming may be a live or pre-recorded broadcast or other stored VOD content or programming. Thus, the live football game a fire station crew is watching on television may be interrupted in real-time by an incoming alert or notification which may temporarily take control. In some embodiments, the incoming alert or notification may prevent the viewer from preempting the broadcast, such as by changing the channel, for example. Likewise, the alert or notification itself may comprise a pre-recorded or live broadcast, such as a message from the President of the United States, for example, or other information such as instructions, advertising, promotional offers, and the like.

Remote control may also comprise the transfer of VOD content or programming to select receiving stations for storage and maintenance, for example. Such VOD content or programming may then be initiated by the receiving station at will. The transfer may occur automatically, periodically, and/or as required by the sender or receiving station.

These and/or other embodiments may also remotely update VOD content or programming maintained and stored by the first-responder. For example, time-sensitive VOD content or programming may be maintained in an update-to-date, complete and accurate manner, such as by the control center from where the content or programming originated. Thus, any instructional or educational VOD content or programming related to proper first-responder protocol, for example, may be remotely (or locally) updated, deleted, added, modified or otherwise maintained in an accurate and reliable manner. Maintenance of the VOD content or programming may be remotely maintained by a government agency coordinating educational programs for first-responders, for example. Thus, the Department of Homeland Security, for example, may maintain an education program over various communication networks whereby it transfers educational VOD content or programming to various first-responders and is thereafter able to remotely initiate such VOD content or programming, e.g., remotely play back, remotely maintain, etc. The Department of Homeland Security may connect to the various first-responders over at least one communication network.

These and/or various other embodiments may assess interaction or behavior at one or any number of receiving stations, such as assessing completion and comprehension of educational VOD content or programming, for example. One such system may comprise an e-learning system whereby the control center, for example, would be able to provide learning or instructional material to various end-users in real-time. Such learning or instruction material may be provided as a live broadcast (e.g. a live seminar), as well as a pre-recorded program which may be accessed on demand, for example. By monitoring the interaction and behavior of the end-users, the system would be able to administer testing and assess score results. Coupled with the ability to remotely control the stored content, such a system may further maintain up-to-date collections of VOD content, for example. In the first-responder exemplary system discussed above, the ability to assess end users would enable the government agency to monitor and track performance of fire and police stations, for example, in response to issued alerts or notifications. The assessment features and functionality may occur over the same communication network through which VOD content or programming is transferred and/or remotely controlled, or over a separate and/or dedicated communication network.

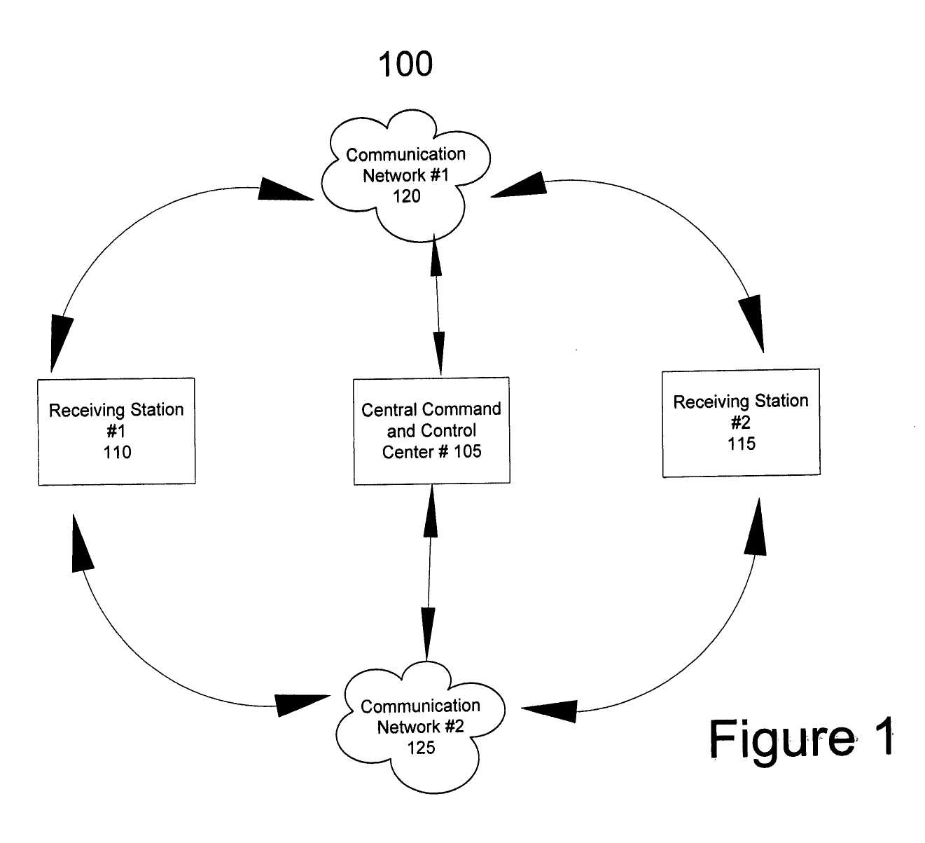

FIG. 1 illustrates a system 100 for transmitting and controlling VOD content or programming according to one embodiment of the invention. System 100 may comprise a control center 105 which may connect to or communicate with any number of receiving stations (e.g., receiving stations 110 and 115) through any number of dedicated communication networks, such as communication networks 120 and 125, for example. According to some embodiments, VOD content or programming may comprise educational or learning videos that are uploaded by control center 105 and transmitted over communication network 120 to receiving stations 110 and 115 for storage and on-demand initiation, for example. In other embodiments, VOD content or programming may comprise alert notifications related to terrorist attacks or natural disasters, anticipated or occurring, for example. Other types of VOD content or programming are possible.

Communications network 120 may comprise any type of communication network able to transmit and receive VOD content or programming and any information related thereto, such as control signals, for example. In one embodiment, communication network 120 may comprise a satellite communications network, such as a direct broadcast communication system (DBS) having the requisite number of dishes, satellites and transmitter/receiver boxes, for example. Communications network 120 may also comprise a telephone communications network, such as the Public Switched Telephone Network (PSTN). In some embodiments, the PSTN may be used to transmit data relating to particular VOD content. In another embodiment, communication network 120 may comprise a Personal Branch Exchange (PBX), which may further connect to the PSTN.

Communications network 120 may also be comprised of, or may interface to any one or more of, the Internet, an intranet, a Personal Area Network (PAN), a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1 or E3 line, a Digital Data Service (DDS) connection, a Digital Subscriber Line (DSL) connection, an Ethernet connection, an Integrated Services Digital Network (ISDN) line, a dial-up port such as a V.90, a V.34 or a V.34bis analog modem connection, a cable modem, an Asynchronous Transfer Mode (ATM) connection, a Fiber Distributed Data Interface (FDDI) connection, or a Copper Distributed Data Interface (CDDI) connection. Communications network 120 may also comprise, include or interface to any one or more of a Wireless Application Protocol (WAP) link, a General Packet Radio Service (GPRS) link, a Global System for Mobile Communication (GSM) link, a Code Division Multiple Access (CDMA) link or a Time Division Multiple Access (TDMA) link such as a cellular phone channel, a Global Positioning System (GPS) link, a cellular digital packet data (CDPD) link, a Research in Motion, Limited (RIM) duplex paging type device, a Bluetooth radio link, or an IEEE 802.11-based radio frequency link. Communications network 120 may further comprise, include or interface to any one or more of an RS-232 serial connection, an IEEE-1394 (Firewire) connection, a Fibre Channel connection, an infrared (IrDA) port, a Small Computer Systems Interface (SCSI) connection, a Universal Serial Bus (USB) connection or another wired or wireless, digital or analog interface or connection.

According to various embodiments of the invention, a second communication network 125 may also be provided to enable additional communication capabilities between control center 105 and receiving stations 110 and 115, for example. For instance, communications network 120 may be used to upload, download, transmit and receive VOD content or programming, for example, while communication network 125 may be used to track and/or assess behavior at the individual receiving stations 110 and 115, for example. Communication networks 120 and 125 may comprise the same network (or type of network) or disparate dedicated network systems. Communication network 125 may comprise any of the networks discussed above in connection with communication network 124. Any number of communication networks may be provided.

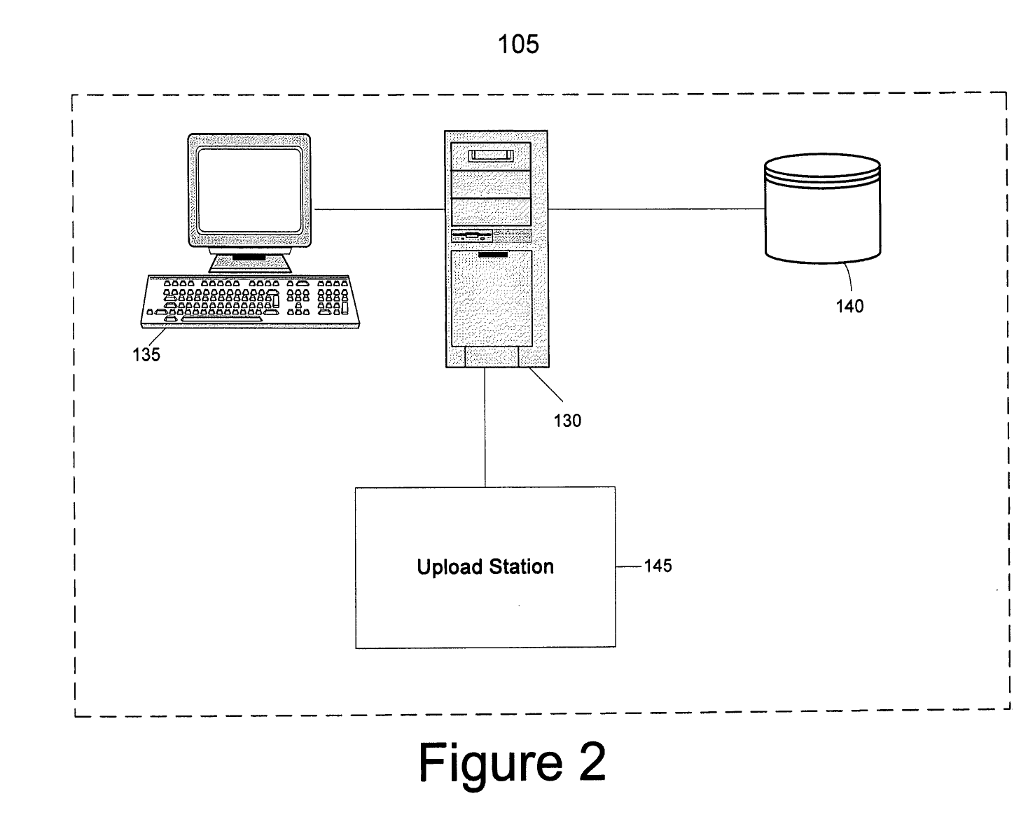

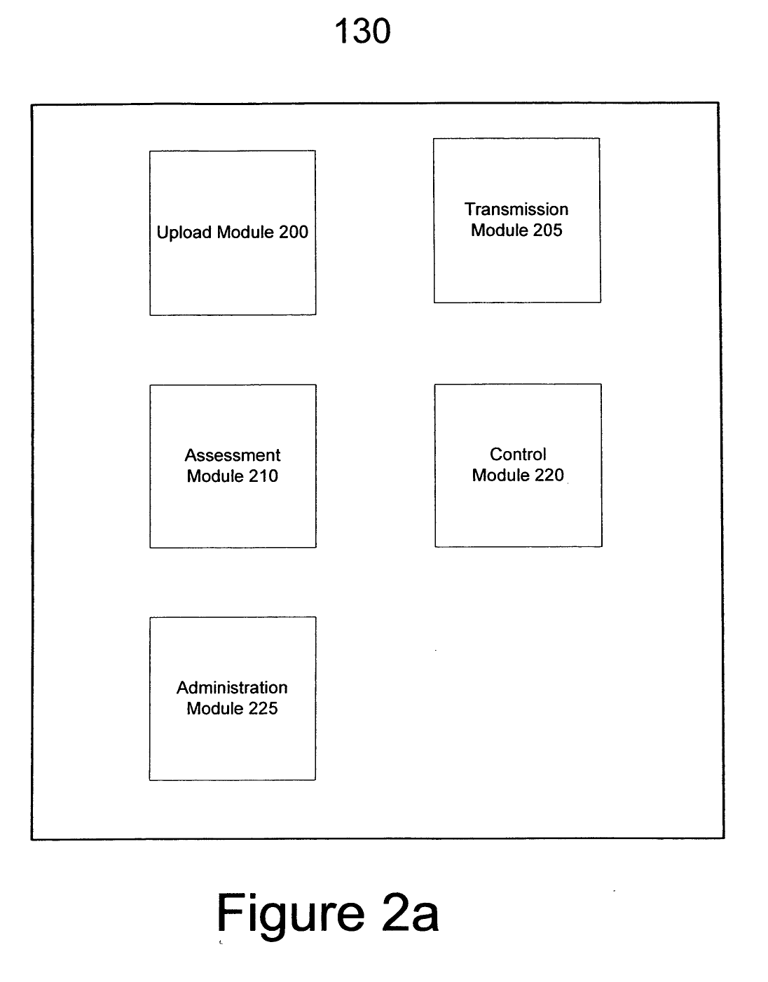

FIG. 2 illustrates an illustrative embodiment of control center 105. According to various embodiments, control center 105 may comprise a VOD facility for uploading, processing and transmitting VOD content or programming, such as one that might be maintained and operated by a cable or satellite provider, for example. In other embodiments, control center 105 may be associated with a government agency or other entity which is responsible for administering various departments or personnel, such as first-responders (e.g., fire and police stations, emergency personnel, etc.). In still other embodiments, control center 105 may comprise a control center dedicated to maintaining and administering educational programming transmitted to and utilized by any number of receiving stations, such as receiving stations 110 and 115, for example. As shown in FIG. 2, control center 105 may comprise a server station 130, a client station 135, database 140, and upload station 145. Each is further described below.

Transmitters 130 may comprise a single server or engine (as shown). In other embodiments, transmitter 130 may comprise a plurality of servers or engines, dedicated or otherwise, which may further host modules for performing desired system functionality. Transmitter 130, for example, may host one or more applications or modules that function to permit interaction between agents of control center 105 and receiving stations 110 and 115 as it relates to the transmission and control of VOD content or programming, for example. Transmitter 130 may include modules that enable control center 105 to upload programming for storage in database 140, for example. Transmitter 130 may also include a module(s) for initiating on-demand functions at receiving stations 110 and 115, for example. Other modules are possible (See FIG. 2a).

Transmitters 130 may include, for instance, a workstation or workstations running the Microsoft Windows™ XP™ operating system, Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform. The functionality described herein may be performed by transmitter 130 may be performed by a single module or set of modules. In some embodiments, transmitter 130 may comprise or represent a transmitter, a personal computer system, or a combination of both.

Client station 135 may comprise an interface system for an agent of control center 105, for example, to interact with and engage the various functionality of transmitter 130 and system 100, for example. Client station 135 may comprise or include, for instance, a personal or laptop computer running a Microsoft Windows™ 95 operating system, a Windows™ 98 operating system, a Millenium™ operating system, a Windows NT™ operating system, a Windows™ 2000 operating system, a Windows XP™ operating system, a Windows CE™ operating system, a PalmOS™ operating system, a Unix™ operating system, a Linux™ operating system, a Solaris™ operating system, an OS/2™ operating system, a BeOS™ operating system, a MacOS™ operating system, a VAX VMS operating system, or other operating system or platform. Client station 135 may include a microprocessor such as an Intel x86-based or Advanced Micro Devices x86-compatible device, a Motorola 68K or PowerPC™ device, a MIPS device, Hewlett-Packard Precision™ device, or a Digital Equipment Corp. Alpha™ RISC processor, a microcontroller or other general or special purpose device operating under programmed control. Client station 135 may further include an electronic memory such as a random access memory (RAM) or electronically programmable read only memory (EPROM), a storage such as a hard drive, a CDROM or a rewritable CDROM or another magnetic, optical or other media, and other associated components connected over an electronic bus, as will be appreciated by persons skilled in the art. Client station 135 may be equipped with an integral or connectable cathode ray tube (CRT), a liquid crystal display (LCD), electroluminescent display, a light emitting diode (LED) or another display screen, panel or device for viewing and manipulating files, data and other resources, for instance using a graphical user interface (GUI) or a command line interface (CLI). Client station 135 may also include a network-enabled appliance such as a WebTV™ unit, a radio-enabled Palm™ Pilot or similar unit, a set-top box, a networkable game-playing console such as a Sony™ Playstation™, Sega™ Dreamcast™ or a Microsoft™ XBox™, a browser-equipped or other network-enabled cellular telephone, or another TCP/IP client or other device.

Client station 135 may be utilized by an agent of control center 105, for example, to input information related to VOD content or programming, including but not limited to transmission information, such as name or title, the intended recipients, etc., and other information related to the maintenance and administration of the VOD content or programming. According to various embodiments, for example, an agent of control center 105 may interface with a graphical user interface (or GUI) to input information related to the scheduling, cataloging, and maintenance of the VOD content or programming, and any other information that may be used to administer maintenance and transmission of such content to various receiving stations, for example. An agent of the control center 105 may also input information relating to VOD content or programming that may be useful to individuals at receiving stations 110 and 115 in deciding which programming they want to download, for example. According to various other embodiments, client station 135 may be used to input information relating to specific alerts or notifications, such as the identification of receiving stations that should receive the alert, as well as identification or designation of the specific alert or notification content.

VOD content or programming maintained by system 105 may be stored and cataloged in database 140, for example. Database 140 may comprise, include or interface to an Oracle™ relational database such as that sold commercially by Oracle Corporation. Other databases, such as an Informix™ database, a Database 2 (DB2) database, a Sybase database, an On Line Analytical Processing (OLAP) query format database, a Standard Query Language (SQL) format database, a storage area network (SAN), a Microsoft Access™ database or another similar data storage device, query format, platform or resource may be used. Database 140 may comprise a single database or a collection of databases, dedicated or otherwise.

Upload station 145 may be used by an agent of control center 105, for example, to upload to control center 105 various VOD content or programming for transmission to receiving stations 110 and 115, for example. Such VOD content or programming may comprise live or pre-recorded content and programming. For instance, upload station may be used to upload the educational programs, alerts or notifications, or any other form of VOD content or programming. Content and programming uploaded by upload station 145 may be stored, cataloged and maintained by database 140, for example.

According to various other embodiments, VOD content may be remotely uploaded. For example, a user of client station 135 may upload VOD content which may subsequently be stored, played, and/or initiated by any user of system 100. Uploading of VOD content may be done at or remotely initiated by receiving station 110 or 115, or by control station 105, for example. In various embodiments, uploading may be done over the Internet, or any other communications network, for example.

FIG. 2a illustrates exemplary modules that may be associated with transmitter 130 for carrying out (or administering) the various functions and features of the embodiments described herein. In some embodiments, the modules may be accessed by an agent of the control center 105, or any proper third party, for example, through appropriate graphical user interfaces (or GUI). While the modules may not be necessary to perform some or all of the functions of the present invention, they are nonetheless presented as possible embodiments:

Upload module 200 may comprise an interface for uploading VOD content or programming through upload station 145, for example. Upload module 200 may, for example, provide the agent of control center 105 with a graphical interface specifying particular functionality related to the uploading, maintenance and storage of VOD content or programming. For instance, upload module 200 may be used to upload various programming related to specific educational programs or lectures which may be downloaded and initiated by any number of receiving stations, such as receiving stations 110 and 115, for example. Upload module 200 may also comprise functionality enabling an agent of control center 105 to compartmentalize uploaded content or programming into specified categories, such as educational materials, testing materials, or alerts and notifications, for example. According to various embodiments, upload module 200 may be associated with upload station 145 and operate to control or administer various functionality of upload station 145.

Transmission Module 205 may be used by an agent of control center 105, for example, to transmit particular VOD content or programming to designated receiving stations, such as receiving stations 110 and 115, for example. For instance, assuming control center 105 comprises the administrative or operational headquarters of an e-learning network or system, transmission module 205 may be used to specify which receiving stations are to receive which particular VOD content or programming. Likewise, if the VOD content or programming comprises an emergency alert or notification, transmission module 205 may be used to designate which particular receiving stations should receive such alert or notification. Transmission module 205 may further enable an agent of control center 105 to remotely interrupt ongoing programming at select receiving stations. According to various embodiments, such alert or notification may comprise news alerts, notifications of anticipated or ongoing emergencies, updates to VOD content or programming stored at receiving stations, advertising, or any other type or form of VOD content or programming. Transmission module 205 may also provide transmission verification for verifying that a particular transmission has been successfully transmitted and received by the intended recipient(s).

Assessment Module 210 may be used by an agent of control center 105, for example, to track, assess or monitor behavior at select receiving stations. For example, assessment module 210 may be used to assess receiver station interaction with downloaded VOD content or programming. In various embodiments, for example, VOD content or programming may comprise educational programming that receiving stations interact with to maintain or comply with certification requirements, for example. Assessment module 210 may then be used to conduct testing of the receiving stations comprehension of such requirements, for example. In other embodiments, assessment module 210 may be used to track, assess or monitor the reaction of receiving stations (such as first responders, for example) to anticipated or occurring emergencies, such as terrorist attacks and natural disasters. In some embodiments, assessment module communicates with receiving stations over the same communication network through which VOD content or programming is transmitted, while in other embodiments it is connected through a separate dedicated network, for example.

Control Module 220 may be used by an agent of control center 105, for example, to remotely administer or control the initiation of VOD content or programming at select receiver stations, such as receiver station 110 or 115, for example. According to some embodiments, the agent may interface with control module 220 to interrupt programming currently playing at select receiving stations, for example, and to further designate specific VOD content or programming to play in its stead. That is, the agent may selectively identify particular receiving stations which are to receive specific alerts or notifications, regardless of whether the identified receiving stations are currently broadcasting programming or not. Control module 220 may also be used to input any information related to the functionality of control center 105, including coordination of the features and functionality of system 100.

Administration Module 225 may be used by an agent of control center, 105, to administer or maintain control center 105 and the entirety of system 100. For example, administration module 225 may permit registration of particular receiving stations, as well as manage the VOD content or programming stored in database 140, for example, or other databases located throughout system 100. Administration module 225 may also be used to grant and deny particular access rights to various users, such as agents of control center 105 and receiving stations 110 and 115, for example. Administration module 225 may also be used to permit messaging between various users, such as between users at receiving stations 110 or 115 and/or control station 105, for example. Such messaging may inform users of overall system status, for example, or may provide any information or content related to the systems and methods described herein. In these embodiments administration module 225 may comprise or include a messaging module for carrying out the described messaging functionality.

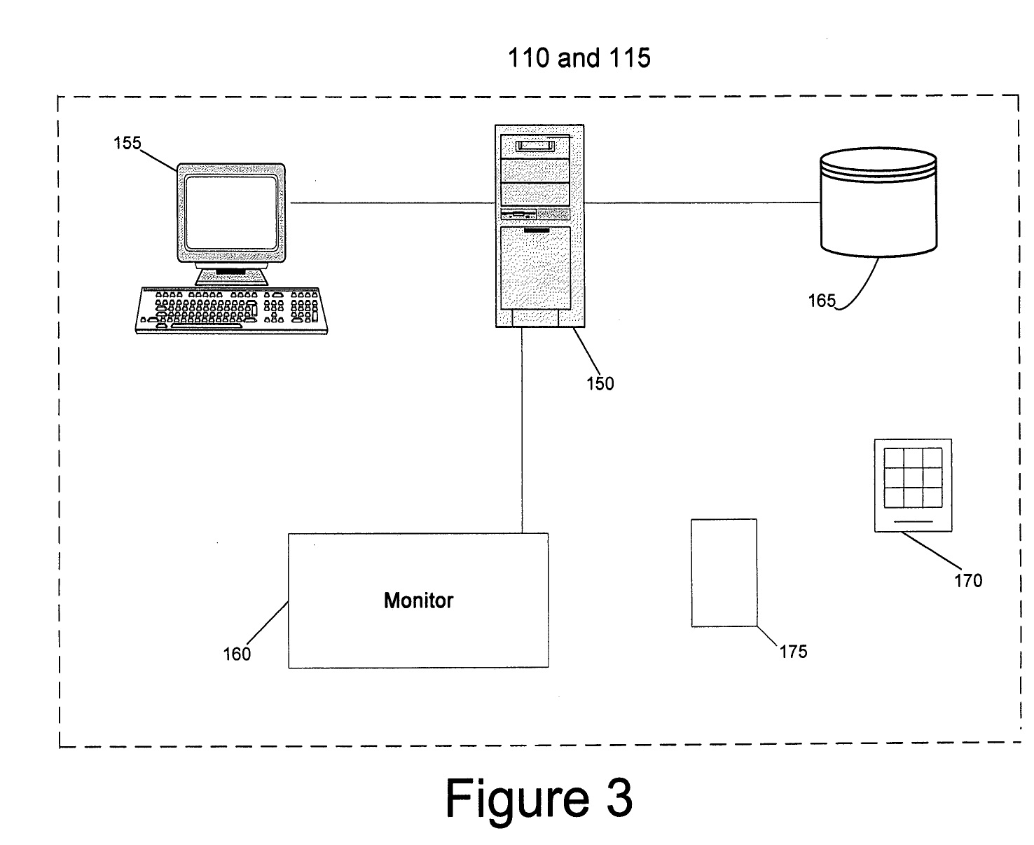

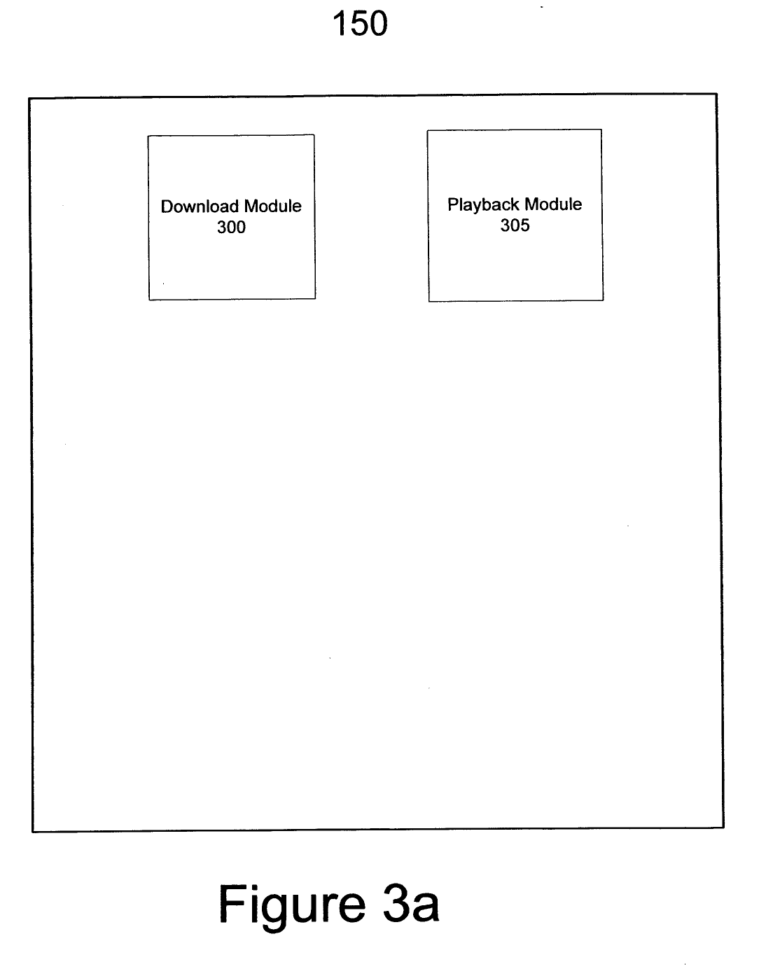

FIG. 3 illustrates one embodiment of receiving stations 110 and 115. According to various embodiments, receiving stations 110 and 115 may consist of a VOD facility for downloading, processing and initiating VOD content or programming, such as might be maintained and cataloged by control center 105, for example. In other embodiments, receiving stations 110 and 115 may be associated with a government agency or other entity which is responsible for administering various departments or personnel, such as first-responders (e.g. fire and police stations, emergency personnel, etc.). As shown in FIG. 3, receiving station 110 and 115 may comprise a receiver 150, a client station 155, monitor 160, database 165, remote control 170, and identification card 175. Each is described in detail.

Receiver 150 may comprise a single server or engine (as shown), such as a receiver or set-top box, or standard home computer system or network, for example. In other embodiments, receiver 150 may comprise a plurality of servers or engines, dedicated or otherwise, which may further host modules for performing desired system functionality. Receiver 150, for example, may host one or more applications or modules that function to permit interaction between agents of receiving stations 110 and 115 and control center 105 as it relates to the transmission reception, and control of VOD content or programming, for example. Receiver 150 may include modules that enable receiving stations 110 and 115 to download VOD content or programming for storage in database 165, for example. Receiver 150 may also include module(s) for initiating on-demand functions for VOD content or programming received from control center 105, for example. Other modules are possible. (See FIG. 3a).

Receivers 150 may include, for instance, a workstation or workstations running the Microsoft Windows™ XP™ operating system, Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform. The functionality described herein may be performed by receiver 150 may be performed by a single module or set of modules.

Client station 155 may comprise an interface means for an agent of receiving station 110 or 115, for example, to interact with and engage the various functionality of receiver 150 and system 100. Client station 155 may comprise or include, for instance, a personal or laptop computer running a Microsoft Windows™ 95 operating system, a Windows™ 98 operating system, a Millenium™ operating system, a Windows NT™ operating system, a Windows™ 2000 operating system, a Windows XP™ operating system, a Windows CE™ operating system, a PalmOS™ operating system, a Unix™ operating system, a Linux™ operating system, a Solaris™ operating system, an OS/2™ operating system, a BeOS™ operating system, a MacOS™ operating system, a VAX VMS operating system, or other operating system or platform. Client station 155 may include a microprocessor such as an Intel x86-based or Advanced Micro Devices x86-compatible device, a Motorola 68K or PowerPC™ device, a MIPS device, Hewlett-Packard Precision™ device, or a Digital Equipment Corp. Alpha™ RISC processor, a microcontroller or other general or special purpose device operating under programmed control. Client station 155 may further include an electronic memory such as a random access memory (RAM) or electronically programmable read only memory (EPROM), a storage such as a hard drive, a CDROM or a rewritable CDROM or another magnetic, optical or other media, and other associated components connected over an electronic bus, as will be appreciated by persons skilled in the art. Client station 155 may be equipped with an integral or connectable cathode ray tube (CRT), a liquid crystal display (LCD), electroluminescent display, a light emitting diode (LED) or another display screen, panel or device for viewing and manipulating files, data and other resources, for instance using a graphical user interface (GUI) or a command line interface (CLI). Examples may include video/television monitors, desktop personal computers, or similar network compatible devices, including hand-help devices, for example. Client station 135 may also include a network-enabled appliance such as a WebTV™ unit, a radio-enabled Palm™ Pilot or similar unit, a set-top box, a networkable game-playing console such as a Sony™ Playstation™, Sega™ Dreamcast™ or a Microsoft™ XBox™, a browser-equipped or other network-enabled cellular telephone, or another TCP/IP client or other device.

Client station 155 may be utilized by an agent of receiving stations 110 or 115, for example, to input information related to VOD content or programming, including but not limited to the name or title of the content, and other information related to the maintenance an initiation of the VOD content or programming. According to various embodiments, for example, an agent of control center 105 may interface with a graphical user interface (or GUI) to input information related to the scheduling, cataloging, and maintenance of the content, and any other information that may be used to administer maintenance and reception of such content from control center 105, for example. An agent of the receiving station 110 or 115 may also input information so as to interact with the VOD content or programming so as to enable assessment by control center 105, for example. According to various other embodiments, client station 135 may be used to input information and interact with specific alerts or notifications, for example. According to various embodiments, users may access client station 135 to access and control content, such as forwarding content to any number of other user access devices, such as other client stations 135, for example.

VOD content or programming downloaded and initiated by receiving station 110 or 115 may be displayed on monitor 160. According to various embodiments, monitor 160 may comprise a standard television or computer monitor. According to various other embodiments, monitor 160 may display VOD content or programming receiving from control center 105, for example, as well as standard broadcast programming received from a cable or satellite provider, or from any broadcasting network or source. Monitor 160 may also receiving content played on a VCR, DVD, or other similar programming source or device.

VOD content or programming downloaded to receiving station 110 or 115 may be stored in database 165, for example. Database 165 may comprise, include or interface to an Oracle™ relational database such as that sold commercially by Oracle Corporation. Other databases, such as an Informix™ database, a Database 2 (DB2) database, a Sybase database, an On Line Analytical Processing (OLAP) query format database, a Standard Query Language (SQL) format database, a storage area network (SAN), a Microsoft Access™ database or another similar data storage device, query format, platform or resource may be used. Database 165 may comprise a single database or a collection of databases, dedicated or otherwise. According to some embodiments, database 165 may be associated with (or part of) a receiver or set-top box, or personal computer system, for example.

According to some embodiments, remote control 170 may be used by an agent of receiver station 110 or 115 to interface with receiver 150 and/or client station 155, as well as to initiate downloaded VOD content or programming, for example. Card 175 may be used to permit control center 105 to identify particular receiving stations, as well as personalize (or filter) incoming VOD content or programming.

FIG. 3a illustrates exemplary modules that may be associated with receiver 150 for carrying out (or administering) the various functions and features of the invention described herein. In one embodiment, the modules may be accessed by an agent of the receiving station 110 or 115, or any proper third party, for example, through appropriate graphical user interfaces (or GUI). While the modules may not be necessary to perform some or all of the functions of the present invention, they are nonetheless presented as possible embodiments:

Download module 300 may used by an agent of receiver station 110 or 115, for example, to interact with system 100 in connection with downloading and initiation of VOD content or programming. According to various embodiments, download module 300 may be used to scan various catalogs of VOD content or programming stored at control center 105, for example. Download module 300 may also be used to designate VOD content or programming for downloading, and to otherwise enable real-time communication between the receiving station and control center 105.

Playback or initiation module 305 may be used to initiate VOD content or programming once it is received by receiving station 110 or 115, for example. Initiation features or functions may include, for example, play, fast-forward, rewind, pause, etc. Playback or initiation module 305 may also enable receiving station 110 or 115 to interact with VOD content or programming, and thus permit control center 105 to track or assess such interaction.

Other modules are possible.

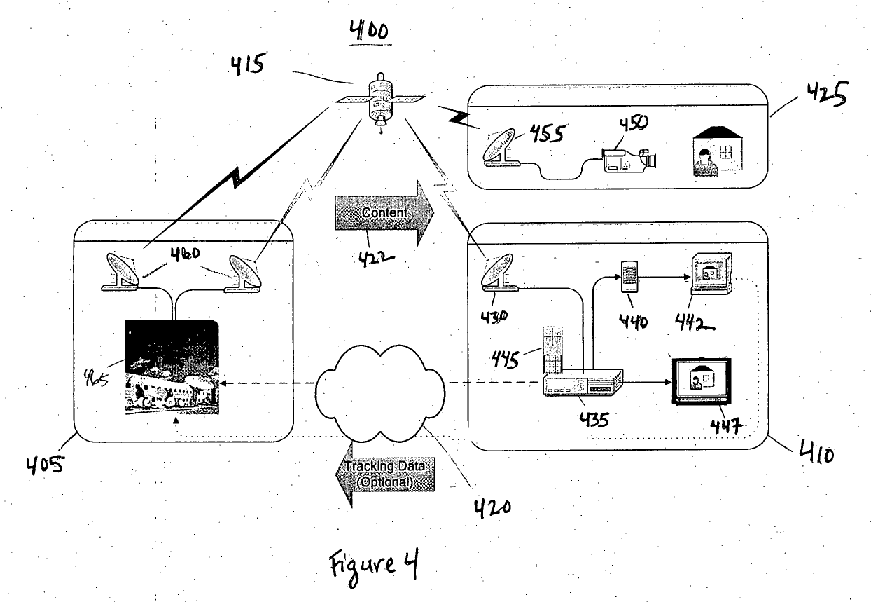

FIG. 4 illustrates one embodiment 400 of system 100 described above. In this embodiment, a control station 405 (or control center 105 above) interacts with receiving station 410 via satellite communications network 415 and the Internet 420. VOD content or programming 422 transmitted over system 400 may be uploaded at upload station 425 over the satellite communications network 420, for example. As shown, satellite communications 420 may be used to transmit VOD content or programming 422, as well as signals or other information or data associated with the uploading, downloading, and initiation thereof. Internet 420 may be used by control center 405 to track or assess the interaction of receiving station 410 with downloaded VOD content or programming, as well as to transmit signals associated with such functionality.

Receiving station 410 may comprise a satellite dish 430, receiver or set-top box 435, server 440, client station 442, remote controller 445, and monitor 447. An agent of receiving station 410, for example, may initiate VOD content or programming downloaded from control center 405, by using remote controller 445 to interact with and engage functionality available through various modules stored on receiver or set-top box 435 or server 440, for example. Each of receiver or set-top box 435, client station 442 and server 440 may be connected to control station 450 via the Internet 420 to enable agents of control station 405, for example, to track, assess and monitor the behavior and interaction of receiver station 410. According to various embodiments, receiving station 410 may comprise a first responder, such as a police or fire station, for example. VOD content or programming 422 may comprise educational content or programming to be initiated by receiving station 410 to comply with certification programs or requirements, for example.

Control station 405 may comprise a satellite dish network 460 which serves to upload live or pre-recorded VOD content or programming from various sources, including upload station 425, for example. Control station 405 may also comprise a headquarter facility containing systems for performing the various functions described above in connection with control station 105. According to various embodiments, control station 405 may comprise a government agency which functions to administer various first-responder receiving stations, including the provision of alerts and notifications and ensuring that certification requirements are met by tracking, assessing and monitoring behavior at receiving station 410.

Upload station 425 may comprise a satellite dish 455 which may be directly or indirectly connected to a camera 450 for recording content or programming for uploading onto control station 405, for example. Other systems and methods for uploading content and programming to control station 405 are possible.

Exemplary methods that may be performed by the various systems described above will now be discussed.

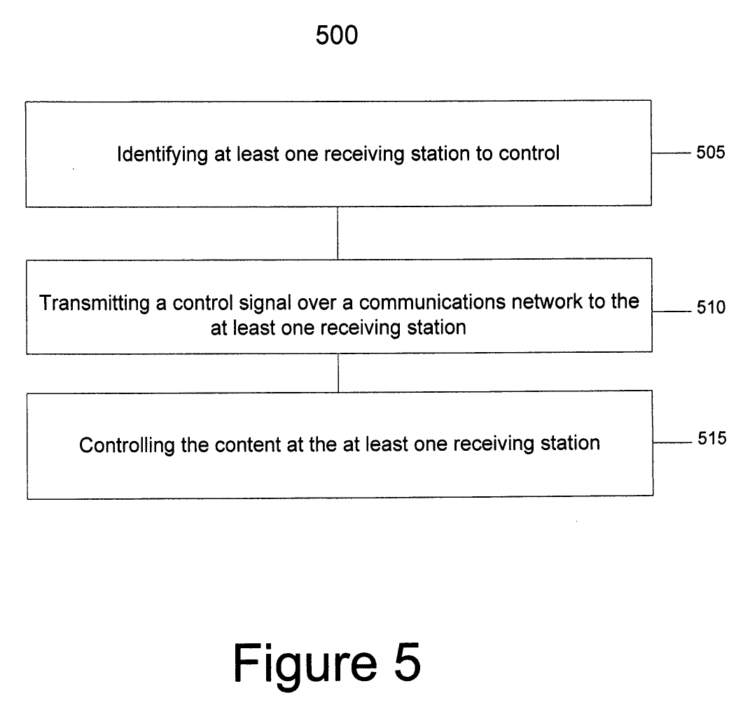

FIG. 5 illustrates a method 500 for remotely controlling content downloaded to at least one receiving station, according to various embodiments of the invention. At step 505, a control center, for example, may identify at least one receiving station to control. According to various embodiments, receiving stations may be identified depending on particular function or purpose. In the case of first responders, for example, receiving stations may be identified depending on whether they provide assistance to injured civilians, or other emergency-related service or function.

At step 510, the control center may transmit at least one control signal, for example, over a communications network to the at least one receiving station. In some embodiments, the control signal may comprise an interrupt signal that serves to interrupt programming which may be playing at the receiving station identified in step 505. Thus, if the receiving station is a police department and the control center wants to inform or alert the police department that a terrorist attack or natural disaster is imminent, it may transmit a signal which interrupts current programming and further transmits the desired alert or notification, for example. In some embodiments, control signals may be sent which operate to administer and maintain a catalog of VOD content or programming stored at the receiving station, such as updating all such content or programming to ensure they are up-to-date and deleting dated or obsolete programming or content. Other forms of control (and signals) are possible. A step 515, the content at the at least one receiving station may be controlled by the at least one control signal.

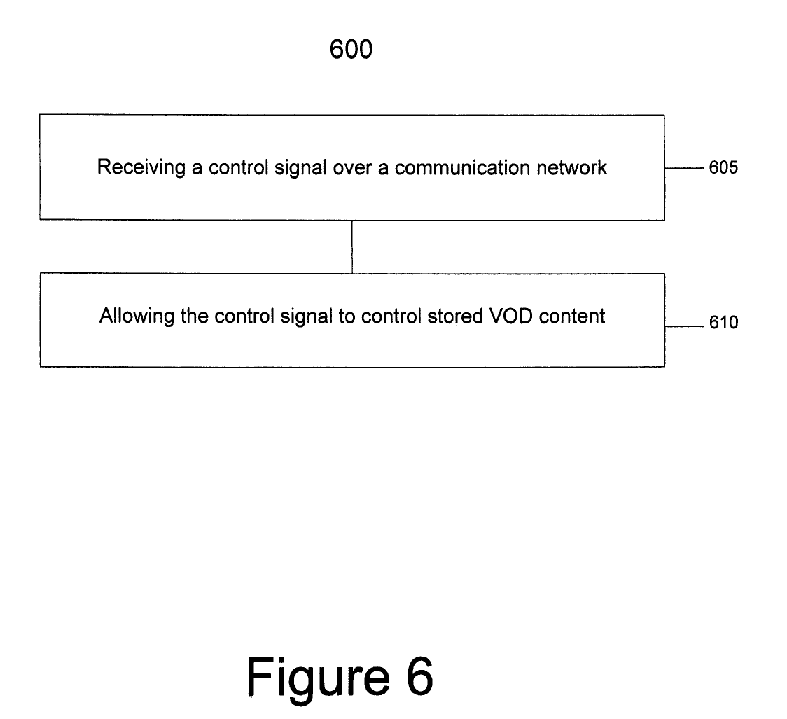

FIG. 6 illustrates a method for controlling VOD content stored at a receiving station. At step 605, a receiving station may receive a control signal over a communications network from a control station. At step 610, the receiving station may allow the control signal to control VOD content or programming stored at the receiving station.

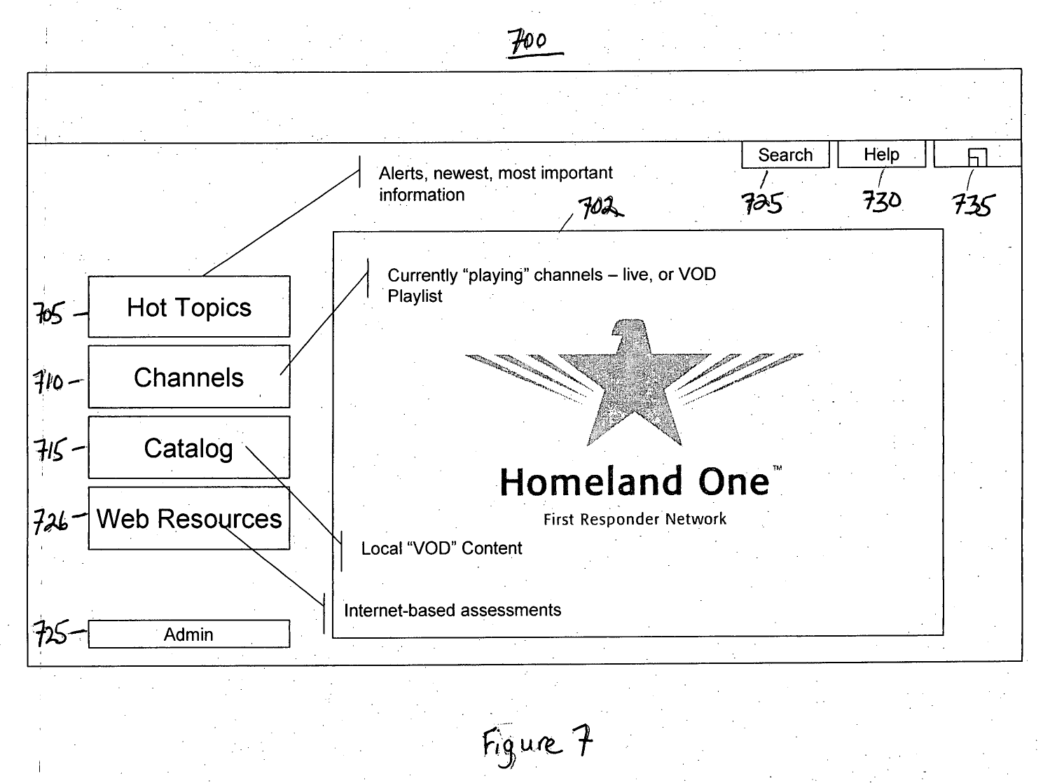

FIGS. 7-14 exemplify various screen shots (or graphical user interfaces (GUIs)) which may enable interaction between users of system 100—e.g., agents of control center 105 and receiving stations 110 and 115, and other third parties—and the various modules and features described above. Other screen shots are possible.

FIG. 7 illustrates one embodiment of a home interface 700 associated with receiving station 110 or 115 of system 100 described above, for example. For FIGS. 7-14, receiving station 110 or 115 will be assumed to be a first-responder having direct connection to the Department of Homeland Security via the Homeland One First Responder Network, as shown. These figures are presented only as an exemplary embodiment and are not intended to limit the scope of the potential applications of the claimed inventions. Home page 700 may also comprise a general screen area 702 for displaying any broadcast content or programming, including VOD content or programming received from control center 105, for example, as well as various features, such as Hot Topics 705, Channels 710, Catalog 715, Web Resources 720, Admin 725, Search 725, Help 730, and Screen presentation format 735. Other features and functionality are of course possible.

Hot Topics 705 may comprise, according to various embodiments, a collection of specific important alerts, messages or notifications. In some embodiments, such alerts, messages and notifications may be received from control center 105, for example. Initiation of such alerts, messages and notifications may be automatic (i.e., immediately played at reception or other predetermined time), as determined by control center 105, as determined by the receiving station, or as scheduled according to predetermined considerations or business rules, such as upon the occurrence of a specific event, for example.

Channels 710 may comprise, according to various embodiments, a play list of currently available channels, which may comprise “live” channels or dedicated VOD channels, for example.

Catalog 715 may comprise, in some embodiments, a catalog of local (i.e., stored locally at the receiving station) or available (e.g., available for downloading from the control center) VOD content or programming.

Web resources 720 may comprise various internet-based assessments, for example, that enable control center 105, for example, to track, assess and monitor the behavior of receiving station 110 or 115. Web resources 720 may include, for example, web-browsing functionality or capabilities enabling users to browse various web sites which may or may not relate to systems and methods disclosed herein.

Administration (or Admin) module 725 may be used by an agent of receiving station 110 or 115, for example, to administer or maintain receiving station 110 or 115. For example, the agent may manage the catalog of local VOD content, adjust or configure the local system parameters, as well as grant or deny access to particular types of users.

Search 725 enables an agent of the receiving station to conduct a keyword search, for example, of stored (local or available) VOD content or programming, or information or data associated therewith. Help 730 allows the agent to access help features and functions, such as a help wizard, for example. Screen presentation format 735 allows for selection of particular display formats for home page 700 and/or screen 702.

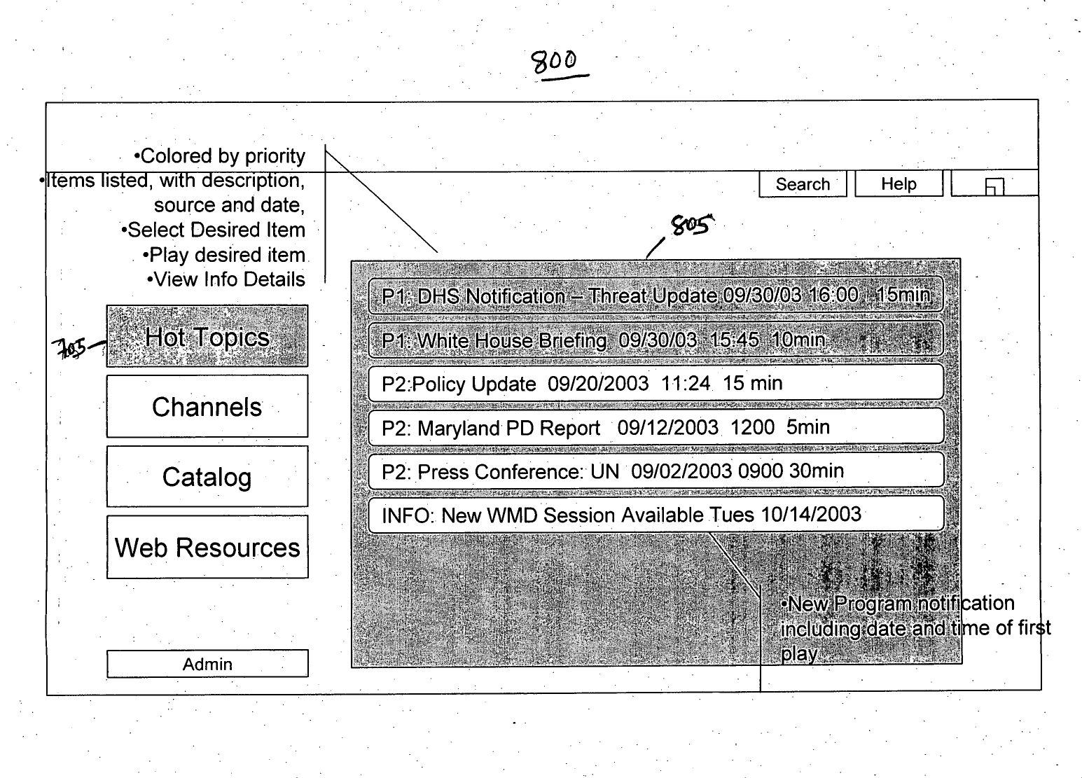

FIG. 8 illustrates one embodiment of a screen page 800 illustrating a select list 805 of VOD content or programming associated with Hot Topics 705. List 805 may comprise a list of alerts or notifications, for example, which have been sent by control center 105, for example, to the receiving station. According to various embodiments, each such alert or notification may be initiated automatically or as determined by the control center 105 and or the receiving station. All such alerts and notifications may be stored and maintained locally by the receiving station, and may further be organized according to order of priority or importance, such as by indicating P1, P2, or associating specific colors, as shown. Information related to each alert or notification may be presented, as shown.

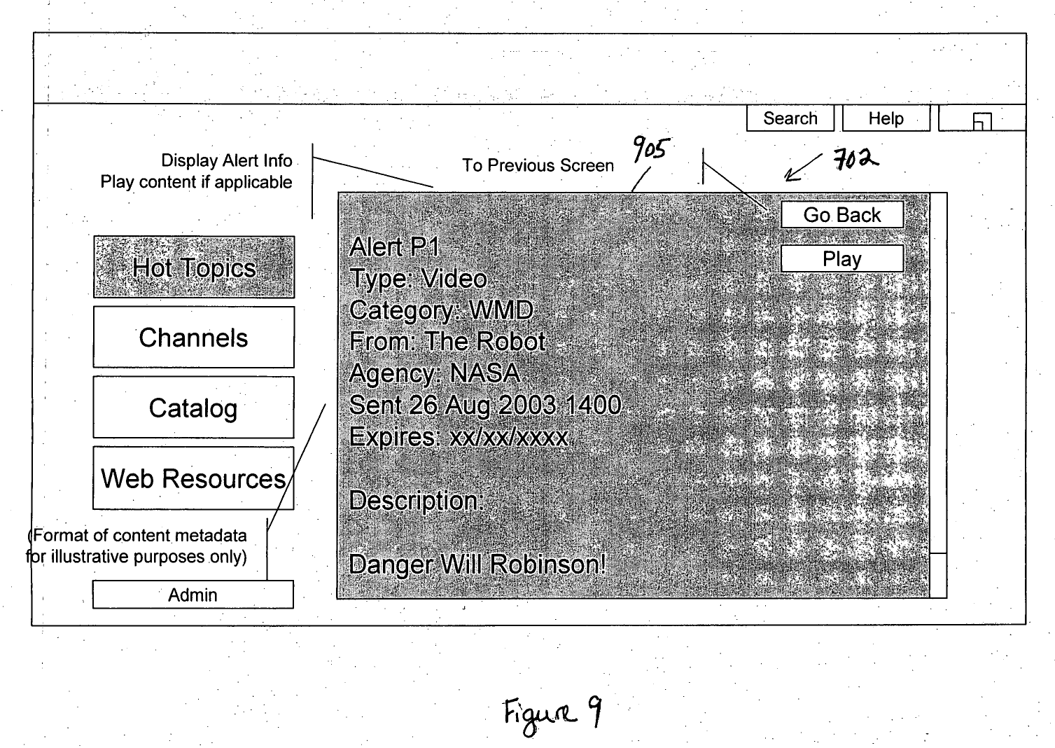

FIG. 9 illustrates one embodiment of an initiated alert 905 being presently displayed on screen area 702. As shown, alert 905 comprises a text message (and associated video) conveying particular information about the alert or notification. Additional meta-data about the alert may also be presented, such as its priority, type, sender, date, and expiration date (if any).

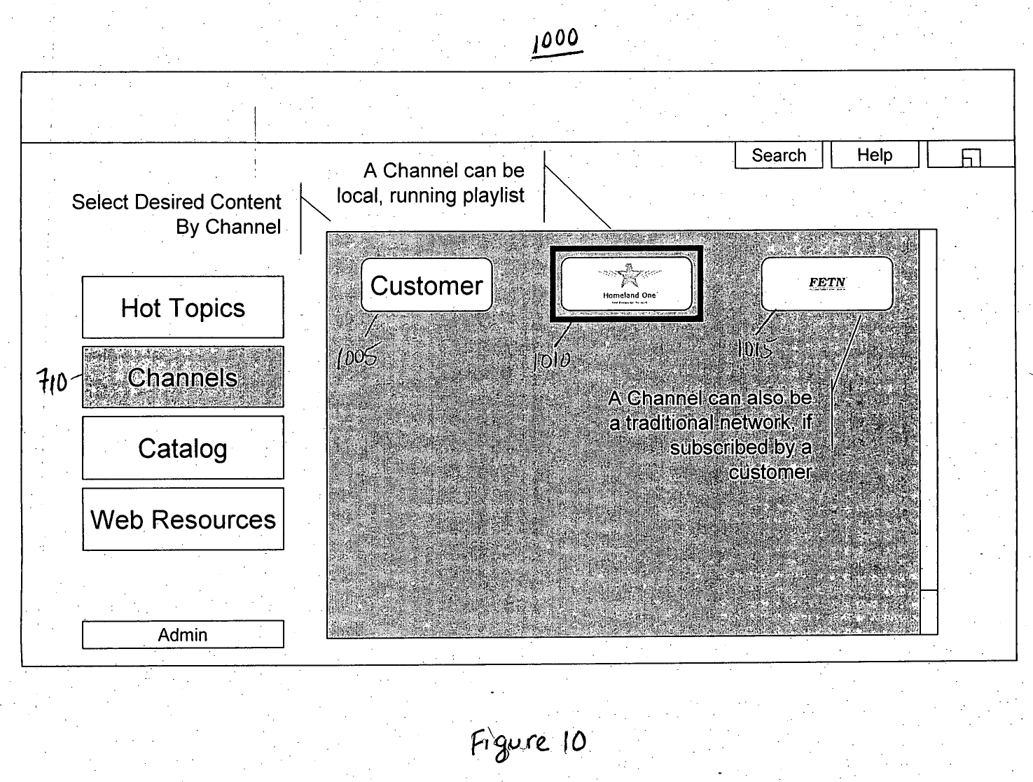

FIG. 10 illustrates one embodiment of a screen shot 1000 associated with channel 710. Screen shot 1000 may illustrate, for example, icons relating the identity of the receiver station (or customer) 1005, the running play list of a particular dedicated VOD channel 1010, and other broadcasting, such as from a traditional network 1015, for example.

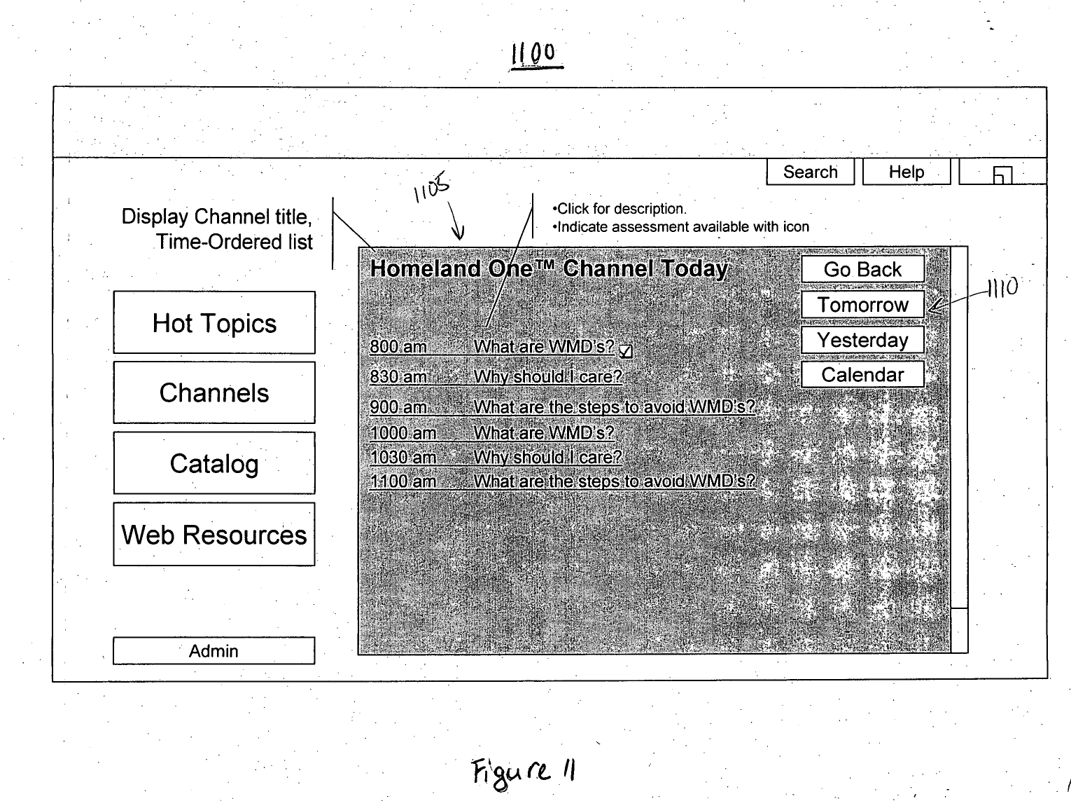

FIG. 11 illustrates one embodiment of a screen shot 1100 displaying the daily play list 1105 associated with Homeland One Channel, for example. Play list 1105 may comprise the schedule of the day's programming, including the title and start time for each program. According to some embodiments, play list 1105 is downloaded to the receiving station daily (or on a predetermined schedule) from control center 105. In some embodiments, each program listed on play list 1105 may be selected for further information. Selections 1110 may also be provided to enable interaction or surfing among the play lists for various days or dates, for example.

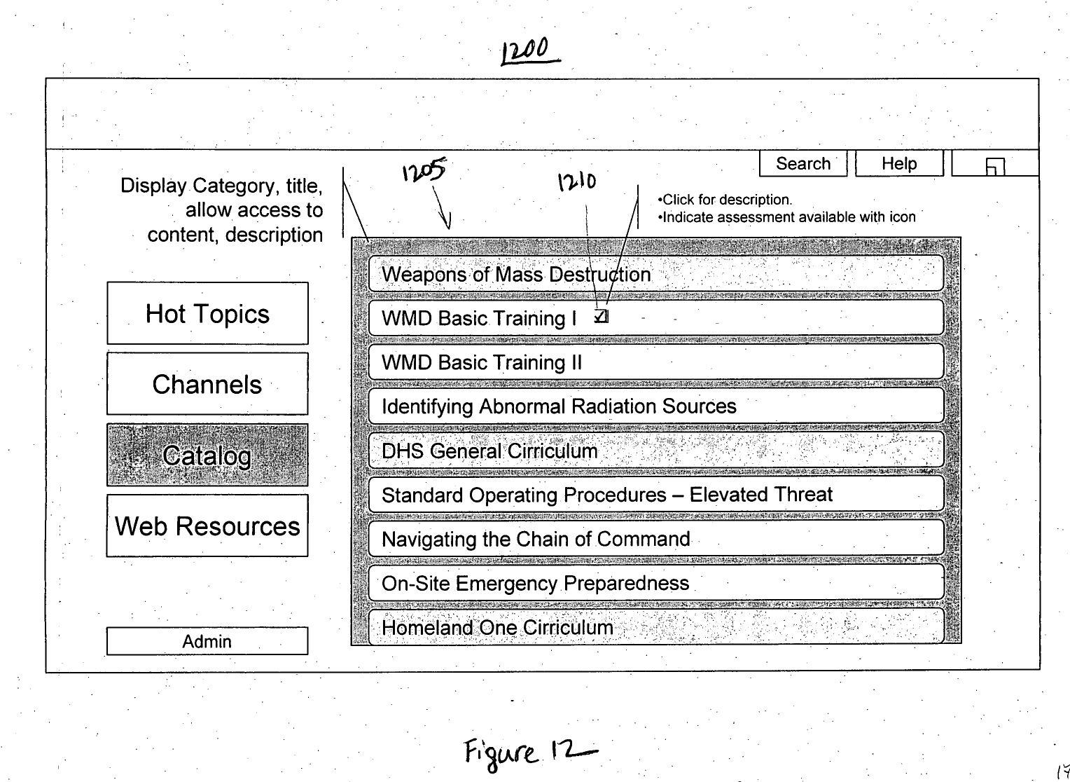

FIG. 12 illustrates one embodiment of a screen shot 1200 displaying the catalog 1205 of stored VOD content or programming. According to some embodiments, catalog 1205 may reflect VOD content or programming stored locally at the receiving station, available VOD content or programming stored at the control center 105, or a combination of both. In some embodiments, each program listed on catalog 1105 may be selected for further information or for initiation. In other embodiments, specific programs listed in catalog 1205 may further indicate the availability of assessment features as indicated by assessment indicator 1210. Assessment features may relate to the ability of control center 105 to monitor the interaction of the receiving station with the particular VOD content or programming. In some embodiments, such assessment-enabled VOD content or programming may comprise educational lectures or programs having testing (i.e. assessment) capabilities over a communication network, such as the Internet, for example.

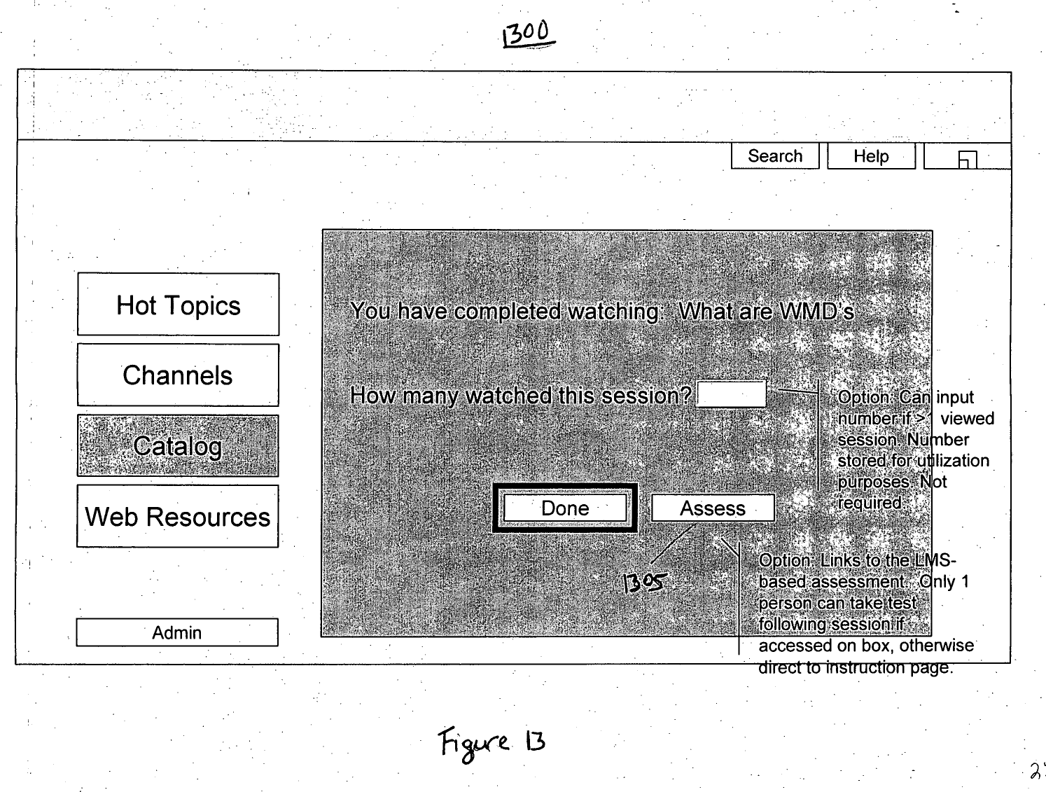

FIG. 13 illustrates one embodiment of a screen shot 1300 displaying a user's completion of VOD content or programming titled “What are WMD's,” and querying the user for information useful to an assessment of user's interaction with the VOD content or programming. According to some embodiments, screen shot 1300 may further comprise an assessment-initiation icon 1305 for initiation of assessment features and functionality, such as testing the user(s) comprehension of the material presented, for example. Other assessment features are possible.

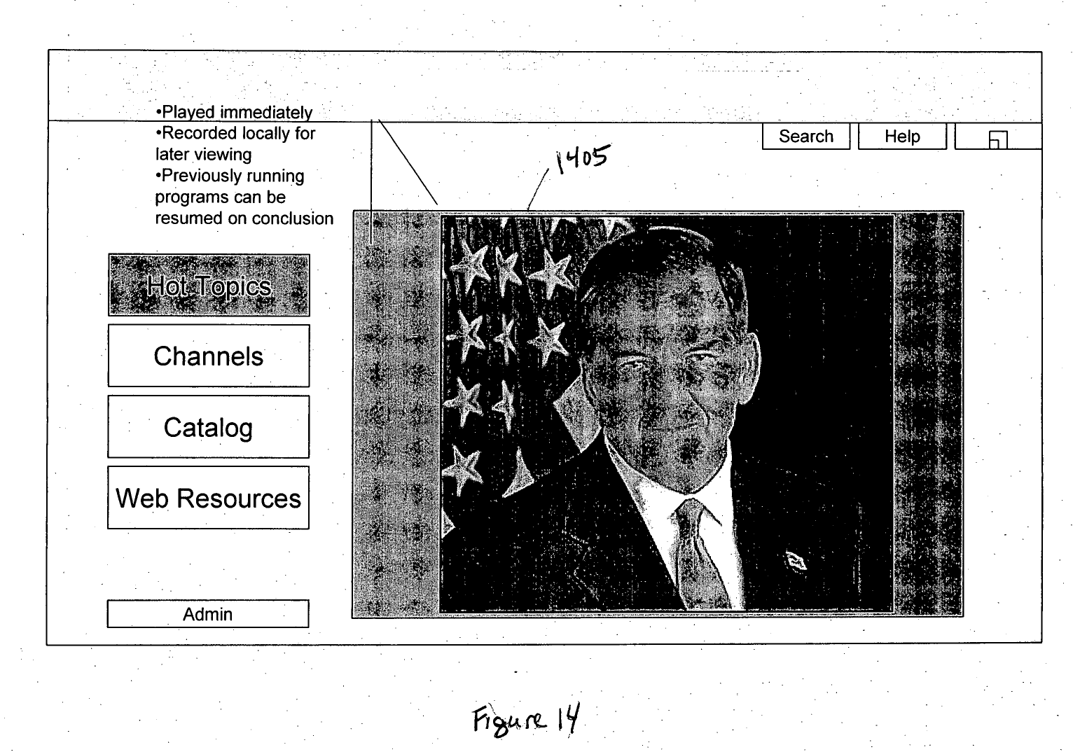

FIG. 14 illustrates one embodiment of a screen shot 1400 displaying an incoming emergency alert or notification 1405. According to some embodiments, the alert or notification 1405 may interrupt ongoing programming which may be playing at the receiving station. In some embodiments, the alert or notification may be played immediately, or may be recorded locally at the receiving station for later viewing. In other embodiments, previously playing programming may resume upon completion of the alert or notification.

Other embodiments, uses and advantages of the present invention will be apparent to those skilled in the art from consideration of the specification and practice of the invention disclosed herein. The specification and examples should be considered exemplary only.

1. A system for remotely controlling playback of VOD content, comprising:
at least one receiving station for receiving and playing VOD content; and
a control station for remotely controlling the VOD content over a communication network, the control station selectively transmitting a control signal to the at least one receiving station for controlling initiation of the VOD content.

2. The system of claim 1 wherein the control signal comprises an interrupt command for interrupting programming playing at the at least one receiving station.

3. The system of claim 2 wherein the interrupt command further comprises content to be played at the at least one receiving station.

4. The system of claim 2 wherein the interrupt is followed by content to be played at the at least one receiving station.

5. The system of claim 4 wherein the content comprises pre-recorded content to be played at the at least one receiving station.

6. The system of claim 4 wherein the content comprises live content to be played at the at least one receiving station.

7. The system of claim 1 wherein the communications network comprises a satellite communications network.

8. The system of claim 1 wherein the communications network comprises the Internet.

9. The system of claim 1 wherein the communications network comprises a cable communications network.

10. A system for transmitting and controlling VOD content, comprising:
at least one receiving station for playing VOD content, the at least one receiving station comprising a downloading module for downloading the VOD content, and at least one storage means for storing the VOD content;
a control station for transmitting the VOD content, the control station comprising a transmission module for transmitting the VOD content over a communications network, and a controlling module for selectively controlling the transmitted VOD content once it is received at the at least one receiving station.

11. The system of claim 10 wherein the control station further comprises an upload module for uploading VOD content.

12. The system of claim 10 wherein the controlling module operates to interrupt ongoing programming at the least one receiving station.

13. The system of claim 10 wherein the controlling module transmits at least one control signal to the at least one receiving station.

14. The system of claim 13 wherein the control signal comprises an alert or notification message.

15. A system for initiating on-demand administration of video content, comprising:
a receiving station having control means for controlling video content; and
a control station for interacting with the control means to remotely administer the video content.

16. The system of claim 15 wherein the control station interacts with the control means to remotely maintain a catalog of video content stored at the receiving station.

17. The system of claim 16 wherein the catalog of video content is updated, modified, verified, or revised by the control station.

18. The system of claim 15 wherein the control station interacts with the control means to remotely initiate the video content.

19. The system of claim 18 wherein control station interrupts programming currently playing at the receiving station, and further initiates a designated alert or notification message.

20. A method for remotely controlling content, comprising:
identifying at least one receiving station to control;
transmitting a control signal over a communications network to the at least one receiving station; and
controlling the content at the at least one receiving station.

21. The method of claim 20 wherein controlling the content at the at least one receiving station comprises interrupting programming.

22. The method of claim 21 further comprising transmitting an alert notification.

23. The method of claim 22 wherein the alert notification comprises at least one of a pre-recorded or live message.

24. The method of claim 20 controlling the content at the at least one receiving station comprises administering or managing content stored at the at least one receiving station.

25. A method for controlling VOD content stored at a receiving station, comprising:
receiving a control signal over a communications network from a control station; and
allowing the control signal to control stored VOD content.

26. The method of claim 25 wherein the VOD content is stored at the receiving station.

27. The method of claim 25 wherein the control signal administers the storage and cataloging of the VOD content.

28. The method of claim 25 wherein the control signal updates the VOD content.

29. The method of claim 25 wherein the control adds or deletes VOD content.

30. A system for remotely controlling VOD, comprising:
means for transmitting VOD content to at least one receiving station; and
means for remotely controlling the VOD content once it is received by the receiving station.

31. The system of claim 30 wherein the transmission means comprises a transmission module.

32. The system of claim 30 wherein the controlling means comprises a control module.

33. The system of claim 30 wherein the VOD content is transmitted over a communications network.

34. The system of claim 32 wherein the control modules controls the VOD content by transmitting a control signal.

35. The system of claim 34 wherein the control signal broadcasts a predetermined alert or notification message to the receiving station.

36. A method for controlling VOD content stored at a receiving station, comprising:
sending a control signal over a communications network to a receiving station; and
controlling stored VOD content via the control signal.

37. A system for controlling VOD content stored at a receiving station, comprising:
means for sending a control signal over a communications network to a receiving station; and
means for controlling stored VOD content via the control signal.

38. A system for controlling VOD content stored at a receiving station, comprising:
means for receiving a control signal over a communications network from a control station; and
means for allowing the control signal to control stored VOD content.

39. The system of claim 1 wherein the VOD content may be encrypted and decrypted.

40. The system of claim 1 wherein the VOD content may be remotely uploaded.

41. The system of claim 1 wherein the VOD content may be remotely requested.

42. The system of claim 1 further comprising a messaging module for permitting messaging over the communication network.

43. The system of claim wherein data relating to the VOD content is transmitted of the Public-Switched Telephone Network (PSTN).
